(19) United States
(12) Patent Application Publication
(10) Pub. No.: US 2025/0390069 A1
(43) Pub. Date: Dec. 25, 2025

(54) REAL-TIME ESTIMATION OF VEHICLE ENERGY CONSUMPTION FOR CONTROL, RANGE ESTIMATION, AND TRIP PLANNING APPLICATIONS

(71) Applicant: FCA US LLC, Auburn Hills, MI (US)

(72) Inventors: Vivek Jairazbhoy, Auburn Hills, MI (US); Stephane Maurel, Poissy (FR); Ludmila Leborgne, Poissy (FR)

(21) Appl. No.: 18/749,842

(22) Filed: Jun. 21, 2024

(51) Int. Cl. G05B 13/02; B60L 58/12

(52) U.S. Cl. CPC G05B 13/027; B60L 58/12

(57) ABSTRACT

An energy consumption estimation and control system for an electrified vehicle includes a memory configured to store a trained energy consumption model configured to estimate an energy consumption of the electrified vehicle, wherein the trained energy consumption model was previously trained offline using training data generated by computer-aided engineering (CAE) software and a control system configured to access the trained energy consumption model from the memory, obtain a plurality of input parameters for the trained energy consumption model based on real-time parameters of the electrified vehicle, utilize the trained energy consumption model and the plurality of input parameters to estimate the energy consumption of the electrified vehicle in real-time, and generate an output based on the estimated energy consumption of the electrified vehicle.

### FIELD

The present application generally relates to electrified vehicles and, more particularly, to real-time energy consumption estimation in electrified vehicles.

### BACKGROUND

Electrified vehicles include a high voltage battery system configured to power one or more electric motors for propulsion. The high voltage battery system has a finite amount of stored energy, and thus accurate real-time estimation of the energy consumption by the electrified vehicle is a crucial aspect of maximizing performance of the electrified vehicle, including the vehicle's range, and of the overall user experience (e.g., trip planning). Conventional energy consumption estimation techniques utilize a road load equation based approach. These physics-based formulations are computationally intensive for real-time (online) execution and thus may require higher performance hardware/controllers. Alternatively, these physics-based formulations would also require substantial experimental validation to provide empirical data (e.g., look-up tables) for real-time estimation. Accordingly, while such conventional vehicle energy consumption estimation techniques do work well for their intended purpose, there exists an opportunity for improvement in the relevant art.

### SUMMARY

According to one example aspect of the invention, an energy consumption estimation and control system for an electrified vehicle is presented. In one exemplary implementation, the energy consumption estimation and control system comprises a memory configured to store a trained energy consumption model configured to estimate an energy consumption of the electrified vehicle, wherein the trained energy consumption model was previously trained offline using training data generated by computer-aided engineering (CAE) software and a control system configured to access the trained energy consumption model from the memory, obtain a plurality of input parameters for the trained energy consumption model based on real-time parameters of the electrified vehicle, utilize the trained energy consumption model and the plurality of input parameters to estimate the energy consumption of the electrified vehicle in real-time, and generate an output based on the estimated energy consumption of the electrified vehicle.

In some implementations, the plurality of input parameters include at least one of ambient temperature, wind speed, wind direction, vehicle mass, battery system state of charge (SOC), road grade, vehicle velocity, and vehicle acceleration. In some implementations, the plurality of input parameters include ambient temperature, wind speed, wind direction, vehicle mass, battery system SOC, road grade, vehicle velocity, and vehicle acceleration. In some implementations, the plurality of input parameters consists of ambient temperature, wind speed, wind direction, vehicle mass, battery system SOC, road grade, vehicle velocity, and vehicle acceleration.

In some implementations, the CAE software is configured to generate the training data across all operating ranges of the electrified vehicle. In some implementations, the trained energy consumption model is a recurrent neural network (RNN). In some implementations, the RNN is a long short-term memory (LSTM) type RNN. In some implementations, the RNN is a gated recurrent unit (GRU) type RNN. In some implementations, the trained energy consumption model is an artificial neural network (ANN). In some implementations, the generated output is an estimated range of the electrified vehicle.

According to another example aspect of the invention, an energy consumption estimation and control method for an electrified vehicle is presented. In one exemplary implementation, the energy consumption estimation and control method comprises storing, at a memory of the electrified vehicle, a trained energy consumption model configured to estimate an energy consumption of the electrified vehicle, wherein the trained energy consumption model was previously trained offline using training data generated by CAE software, accessing, by the control system and from the memory, the trained energy consumption model from the memory, obtaining, by the control system, a plurality of input parameters for the trained energy consumption model based on real-time parameters of the electrified vehicle, utilizing, by the control system, the trained energy consumption model and the plurality of input parameters to estimate the energy consumption of the electrified vehicle in real-time, and generating, by the control system, an output based on the estimated energy consumption of the electrified vehicle.

In some implementations, the plurality of input parameters include at least one of ambient temperature, wind speed, wind direction, vehicle mass, battery system SOC, road grade, vehicle velocity, and vehicle acceleration. In some implementations, the plurality of input parameters include ambient temperature, wind speed, wind direction, vehicle mass, battery system SOC, road grade, vehicle velocity, and vehicle acceleration. In some implementations, the plurality of input parameters consists of ambient temperature, wind speed, wind direction, vehicle mass, battery system SOC, road grade, vehicle velocity, and vehicle acceleration.

In some implementations, the CAE software is configured to generate the training data across all operating ranges of the electrified vehicle. In some implementations, the trained energy consumption model is an RNN. In some implementations, the RNN is an LSTM type RNN. In some implementations, the RNN is a GRU type RNN. In some implementations, the trained energy consumption model is an ANN. In some implementations, the generated output is an estimated range of the electrified vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example energy consumption estimation and control system according to the principles of the present application; and

FIG. 2 is a flow diagram of an example energy consumption estimation and control method for an electrified vehicle according to the principles of the present application.

### DESCRIPTION

As previously discussed, conventional energy consumption estimation techniques utilize a road load equation based approach. These physics-based formulations are computationally intensive for real-time (online) execution and thus may require higher performance hardware/controllers. Alternatively, these physics-based formulations would also require substantial experimental validation to provide empirical data (e.g., look-up tables) for real-time estimation. In a first conventional approach, for example, the longitudinal dynamics of the vehicle are modeled by applying Newton's second law. By modeling each force, the power required by the vehicle's powertrain can be calculated. The total energy consumption is then calculated by adding the auxiliary power, which is assumed to be constant, to the powertrain power. The challenge lies in the accurate determination of all of these vehicle and environmental parameters (rolling resistance, aerodynamic drag, air density, road grade, wind velocity, etc.), which results in many of these parameters being loosely estimated.

Accordingly, improved energy consumption estimation and control techniques for electrified vehicles are presented herein. These techniques train a machine-learning model, such as a recurrent neural network (RNN, such as a long short-term memory (LSTM) or gate recurrent unit (GRU) type network) or an artificial neural network (ANN) using training data generated offline by more powerful computer-aided engineering (CAE) software. This CAE software is capable of simulating driving conditions across the vehicle's entire operating range. The model is trained and validated by comparing energy consumption predictions against selected operating points in different vehicle operating regimes. Example parameters include ambient temperature, wind speed/direction, vehicle mass, battery system state of charge (SOC), road grade, and vehicle speed/acceleration. The output of the trained model is a real-time estimation of vehicle power consumption, which can be integrated over time to estimate the vehicle's energy consumption.

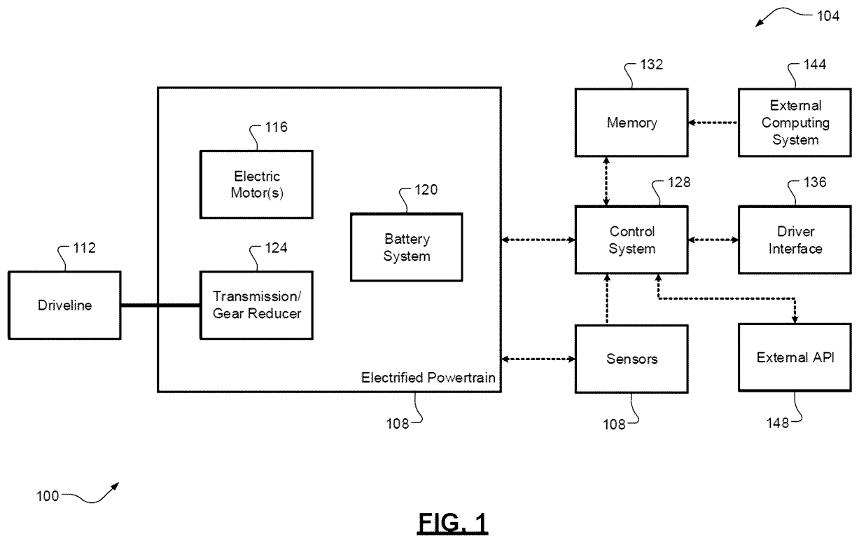

Referring now to FIG. 1, a functional block diagram of an electrified vehicle 100 having an example energy consumption estimation and control system 104 according to the principles of the present application is illustrated. The electrified vehicle 100 generally comprises an electrified powertrain 108 configured to generate and transfer drive torque to a driveline 112 for propulsion. As shown, the electrified powertrain 108 includes an electric motor 116 (e.g., an electric traction motor) that is powered by electrical energy supplied by a high voltage battery system 120. The electric motor 116 is configured to transfer its generated torque directly, via a gear reducer, or via a transmission 124 (a multi-speed automatic transmission, a continuously variable transmission, etc.) to the driveline 112. While not shown, it will be appreciated that the electrified powertrain 108 could include other energy sources, such as an internal combustion engine and/or a fuel cell system. These other energy sources could be configured to generate additional mechanical or electrical energy, such as for powering the driveline 112 or for recharging the battery system 120. A control system 128, having an integrated or separate memory 132 (e.g., a non-volatile memory, or NVM), controls operation of the electrified vehicle 100. This primarily includes controlling the electrified powertrain 108 to generate a desired amount of drive torque in satisfaction of a driver torque request received via a driver interface 136 (e.g., an accelerator pedal).

The control system 128 can perform its control of the electrified powertrain 108 based further on measured operating parameters from a plurality of sensors 140. The plurality of sensors 140 are configured to measure operating parameters such as speeds/accelerations, pressures, temperatures, electrical parameters (voltage, current, etc.), and the like, which could be real-time (online) inputs for the trained energy consumption model as part of the techniques of the present application. In some implementations, at least some of the operating parameters (wind speed/direction, road grade, etc.) could be provided via an external application programming interface (API) 148 (e.g., a cloud-based server) via wireless (e.g., cellular) or “over-the-air” (OTA) communication. The control system 128 is also configured to model other operating parameters of the electrified vehicle 100 based on at least some of these measured parameters. For example, a state of charge (SOC) of the battery system 120 could be modeled based on measured electrical parameters, such as using a Kalman filter type estimation. Other parameters, which will be discussed in greater detail below, could also be modeled or estimated by the control system 128, which is also configured to perform at least a portion of the techniques of the present application. Some aspects of the present application could also be performed by an external calibration or computing system 144.

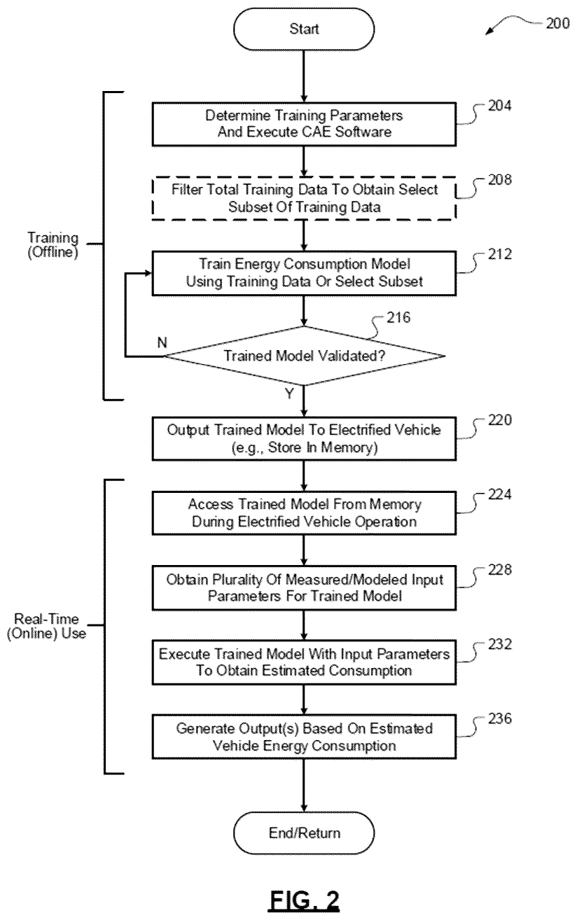

Referring now to FIG. 2, a flow diagram of an example energy consumption estimation and control method 200 for an electrified vehicle according to the principles of the present application is illustrated. While the method 200 specifically references the electrified vehicle 100 and its components for illustrative/descriptive purposes, it will be appreciated that the method 200 could be applicable to any suitably configured electrified vehicle. The method 200 begins at 204 where a training phase for the energy consumption model begins. Specifically, at 204, the external computing system 144 executes CAE software (Gamma Technologies® GT Suite, Siemens® AMESIM, etc.) across all operating regions of the electrified vehicle 100 (e.g., all possible operating regions/conditions of the electrified vehicle) to generate training data. At 208, the training data is optionally filtered to select a subset of energy consumption values across varying operating regions of the electrified vehicle 100. The CAE software executes a detailed, physics-based model that requires a relatively limited number of physical tests/experiments to calibrated. Once calibrated, running thousands of simulations covering the entire operating range of the electrified vehicle 100 becomes a tractable task. In addition, the CAE software can output auxiliary quantities that are difficult to measure in a laboratory but are useful in real-time.

The training data generated by the CAE software includes energy consumption estimations or values for specific operating parameters of the electrified vehicle 100 (e.g., a specific combination of operating parameters). Acquiring this training dataset is not routine in the art. More particularly, it is necessary to (i) identify compatible inputs to the chosen neural network that form a sufficient set to capture the system behavior, but also that are either measurable (e.g., calculated, estimated, or modeled) in real-time and (ii) to assemble these inputs, some of which are usually constant or slowly varying in practical driving (e.g., vehicle mass and ambient temperature) while others (e.g., vehicle speed and vehicle acceleration) are constantly varying, into a strategy that is amenable to the collection of training data for a time series (RNN) or a static (ANN) data science model, and to also define commensurate training procedures. Computational bandwidth (hardware) and storage limitations may determine the type of model/neural network to be used, as time series type networks (e.g., RNNS, such as LSTMs and GRUs) are more resource-intensive than static type networks (e.g., ANNs). While an ANN-type model has no ability to capture dynamic/history effects, it still may provide adequate energy consumption modeling accuracy for certain electrified vehicle applications.

At 212, the external computing system 144 trains the energy consumption model based on the training data (or the filtered training data) to obtain a trained energy consumption model. For time series type networks (RNNs), the training requires training with transient cycles that cover the entire range of electrified vehicle operation. Thus, simulations over the entire operating space to generate a “space-filling” dataset can be used to train an RNN-type model. This could include, for example, a concatenation of United States Environmental Protection Agency (EPA) and other standard cycles that may be used for their velocity profiles, but custom cycles that better explore the entire operating space are preferrable. For example, the design of experiment (DOE) for the CAE software could be to generate training data include the following parameters for each simulation cycle/test: (1) ambient temperature (T_{amb}, e.g., −20° Celsius to 45° Celsius), (2) wind speed (v_{wind}, e.g., 0 meters per second (m/s) to 10 m/s), (3) wind direction (θ_{wind}, e.g., −90° to 90°), (4) vehicle mass (Mᵥ, e.g., 3300 kilograms (kg) to 4100 kg), (5) SOC (SOCᵢ, e.g., 10% to 95%), (6) road grade (RG, e.g., −7% to 7%), (7) vehicle speed (vᵥₑₕ, e.g., in m/s), and (8) vehicle acceleration (aᵥₑₕ, e.g., in m/s²).

As mentioned, the output of the CAE software could be more complex/detailed than a simple energy consumption value. For example, the CAE software could generate, for each simulation or test cycle, a plurality of different output traces including a plurality of power consumption values. In one exemplary implementation, the plurality of output traces generated by the CAE software include (1) distance traveled (s, e.g., in m), (2) time elapsed (t, e.g., in s), (3) vehicle speed vᵥₑₕ, (4) vehicle acceleration aᵥₑₕ, (5) total power loss (P, e.g., in kilowatts or kW), (6) powertrain power loss (P_{PT}, e.g., in kW), (7) auxiliary power loss (P_{AUX}, e.g., in kW), (8) wind power loss (P_{W}, e.g., in kW), (9) road grade power loss (P_{RG}, e.g., in kW), (10) regenerative braking power loss (P_{RB}, e.g., in kW), (11) friction braking power loss (P_{FB}, e.g., in kW), and (12) SOC change over the test/cycle (ΔSOC, e.g., in % of SOC). The powertrain power loss PPT can include any components of the electrified powertrain 108 (electric motor losses, transmission losses, power electronics losses, such as inverter losses, etc.) including intermediary components that are not specifically illustrated or discussed herein (gearbox, bearings, driveshafts, etc.). The driveline 112, while only generally discussed, includes a conventional friction braking system and, optionally, a regenerative braking system, which could utilize a separate electric motor or the electric motor 116 to convert kinetic energy of the electrified vehicle 100 into electrical energy, such as for recharging the battery system 120.

At 216, the output/performance of the trained energy consumption model is validated to ensure a desired accuracy. When validated, the method 200 proceeds to 220. Otherwise, the method 200 returns to 212 where further training continues until the desired accuracy is achieved for validation. At 220, the trained energy consumption model is loaded into the memory 132 of the electrified vehicle 100. At 224, the real-time (online) usage phase of the trained energy consumption model begins. Specifically, at 224, the control system 128 access the trained energy consumption model from the memory 132. At 228, the control system 128 obtains a plurality of input parameters for the trained energy consumption model. In one exemplary implementation, the plurality of input parameters include (1) ambient temperature T_{amb}, (2) wind speed v_{wind}, (3) wind direction θ_{wind}, (4) vehicle mass Mᵥ, (5) battery system SOC SOCᵢ, (6) road grade RG, (7) vehicle speed vᵥₑₕ, and (8) vehicle acceleration aᵥₑₕ. It will be appreciated that these same parameters could be generated as part of the training data by the CAE software as previously discussed. It will also be appreciated that the CAE software could generate more detailed training data (i.e., training data including additional parameters). In some implementations, the plurality of input parameters could include a subset of the above-described eight parameters. However, in one exemplary implementation, the plurality of input parameters consists of only these eight input parameters, which was found to provide a desired level of energy consumption estimation accuracy.

At 232, the control system 128 executes the trained energy consumption estimation model using the plurality of input parameters to obtain an energy consumption estimation. As previously discussed herein, in some implementations, the trained energy consumption estimation model is configured to initially output an estimated power consumption by the electrified vehicle 100, which could then be integrated over time to determine the estimated energy consumption of the electrified vehicle 100. At 236, the control system 128 generates one or more outputs based on the estimated energy consumption of the electrified vehicle 100. In one aspect, for example, the control system 128 could control operation of the electrified vehicle 100, such as controlling the electrified powertrain 108, based on the estimated energy consumption. In another aspect, for example, the control system 128 could estimate a remaining range of the electrified vehicle 100 (e.g., in miles or kilometers). For example only, the estimated vehicle range could be output to the driver interface 136 and then displayed on a display (an instrument panel cluster, a vehicle infotainment display, etc.) of the driver interface 136 for viewing by the driver. In yet another aspect, for example, the control system 128 could alter a trip plan or generate an output or suggestion to a user in planning a trip (e.g., a route) for the electrified vehicle 100 to follow in the future. The method 200 then ends or returns to 204 for one or more additional cycles.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An energy consumption estimation and control system for an electrified vehicle, the energy consumption estimation and control system comprising:
a memory configured to store a trained energy consumption model configured to estimate an energy consumption of the electrified vehicle, wherein the trained energy consumption model was previously trained offline using training data generated by computer-aided engineering (CAE) software; and
a control system configured to:
access the trained energy consumption model from the memory;
obtain a plurality of input parameters for the trained energy consumption model based on real-time parameters of the electrified vehicle;
utilize the trained energy consumption model and the plurality of input parameters to estimate the energy consumption of the electrified vehicle in real-time; and
generate an output based on the estimated energy consumption of the electrified vehicle.

2. The energy consumption estimation and control system of claim 1, wherein the plurality of input parameters include at least one of ambient temperature, wind speed, wind direction, vehicle mass, battery system state of charge (SOC), road grade, vehicle velocity, and vehicle acceleration.

3. The energy consumption estimation and control system of claim 1, wherein the plurality of input parameters include ambient temperature, wind speed, wind direction, vehicle mass, battery system SOC, road grade, vehicle velocity, and vehicle acceleration.

4. The energy consumption estimation and control system of claim 1, wherein the plurality of input parameters consists of ambient temperature, wind speed, wind direction, vehicle mass, battery system SOC, road grade, vehicle velocity, and vehicle acceleration.

5. The energy consumption estimation and control system of claim 1, wherein the CAE software is configured to generate the training data across all operating ranges of the electrified vehicle.

6. The energy consumption estimation and control system of claim 1, wherein the trained energy consumption model is a recurrent neural network (RNN).

7. The energy consumption estimation and control system of claim 6, wherein the RNN is a long short-term memory (LSTM) type RNN.

8. The energy consumption estimation and control system of claim 6, wherein the RNN is a gated recurrent unit (GRU) type RNN.

9. The energy consumption estimation and control system of claim 1, wherein the trained energy consumption model is an artificial neural network (ANN).

10. The energy consumption estimation and control system of claim 1, wherein the generated output is an estimated range of the electrified vehicle.

11. An energy consumption estimation and control method for an electrified vehicle, the energy consumption estimation and control method comprising:
storing, at a memory of the electrified vehicle, a trained energy consumption model configured to estimate an energy consumption of the electrified vehicle, wherein the trained energy consumption model was previously trained offline using training data generated by computer-aided engineering (CAE) software;
accessing, by the control system and from the memory, the trained energy consumption model from the memory;
obtaining, by the control system, a plurality of input parameters for the trained energy consumption model based on real-time parameters of the electrified vehicle;
utilizing, by the control system, the trained energy consumption model and the plurality of input parameters to estimate the energy consumption of the electrified vehicle in real-time; and
generating, by the control system, an output based on the estimated energy consumption of the electrified vehicle.

12. The energy consumption estimation and control method of claim 11, wherein the plurality of input parameters include at least one of ambient temperature, wind speed, wind direction, vehicle mass, battery system state of charge (SOC), road grade, vehicle velocity, and vehicle acceleration.

13. The energy consumption estimation and control method of claim 11, wherein the plurality of input parameters include ambient temperature, wind speed, wind direction, vehicle mass, battery system SOC, road grade, vehicle velocity, and vehicle acceleration.

14. The energy consumption estimation and control method of claim 11, wherein the plurality of input parameters consists of ambient temperature, wind speed, wind direction, vehicle mass, battery system SOC, road grade, vehicle velocity, and vehicle acceleration.

15. The energy consumption estimation and control method of claim 11, wherein the CAE software is configured to generate the training data across all operating ranges of the electrified vehicle.

16. The energy consumption estimation and control method of claim 11, wherein the trained energy consumption model is a recurrent neural network (RNN).

17. The energy consumption estimation and control method of claim 16, wherein the RNN is a long short-term memory (LSTM) type RNN.

18. The energy consumption estimation and control method of claim 16, wherein the RNN is a gated recurrent unit (GRU) type RNN.

19. The energy consumption estimation and control method of claim 11, wherein the trained energy consumption model is an artificial neural network (ANN).

20. The energy consumption estimation and control method of claim 11, wherein the generated output is an estimated range of the electrified vehicle.
